(19) United States
(12) Patent Application Publication
(10) Pub. No.: US 2007/0114338 A1
(43) Pub. Date: May 24, 2007

(54) Vertical pipe guard

(76) Inventors: Martin Boudreau, Boisbriand (CA); Jean-Pierre Thibault, Terrebonne (CA)

Correspondence Address: Eric Fincham, 316 Knowlton Road, Lac Brome, QC, J0E 1V0, CA

(21) Appl. No.: 11/282,373

(22) Filed: Nov. 18, 2005

(51) Int. Cl. E21F 17/02; F16L 3/00

(52) U.S. Cl. 248/58

(57) ABSTRACT

A pipe support assembly which comprises a main body having a U-shaped recess therein, and a cover member for the body, the cover member having an arcuate configuration and being sized to fit between the first and second side walls, each of the cover members and body having a channel or a recess designed to receive a tie wrap to secure a pipe in position. The main body portion also has a clamping portion which comprises first and second resilient members.

### FIELD OF THE INVENTION

The present invention relates to a pipe support system and more particularly, relates to a pipe support system for vertically extending pipes.

### BACKGROUND OF THE INVENTION

In the installation of pipes and the like in various types of buildings and in particular pipes associated with air conditioning, refrigeration and heating, such as may be utilized in many commercial and industrial establishments, conventional practice is that the pipes are hung from the ceiling by strap hangers.

The most common type of strap hanger employed in the industry comprises a metal strap having apertures for fastening purposes. The strap is looped about the pipe to be secured and then a fastening such as a screw or a similar member is secured to a substrate such as a beam or rafter through the apertures. A similar arrangement is employed when the pipes follow a vertical outline as is also frequently required in their transporting of a fluid from one location to another.

This conventional means of fastening pipes suffers from several disadvantages. Initially, each pipe must be installed individually and as such the installation process is relatively labour intensive. Secondly, the hangers can cause rupturing of the pipes after a period of time. This would occur due to movement of the pipe within the pipe hanger and subsequent surface damage. This movement can occur either due to mechanical vibrations, and/or to a thermal expansion and contraction.

### SUMMARY OF THE INVENTION

It is an object of the present invention to provide a pipe support system which may be used in vertical runs of pipes.

According to one aspect of the present invention, there is provided a pipe support assembly comprising a body having a recess formed therein, the recess having a generally U-shaped configuration and being open at a top end thereof, the recess being defined by a bottom wall and first and second side walls, a plurality of ribs on an exterior surface of the bottom wall, at least four of the ribs extend transversely thereof to define first and second spaced apart body channels, a clamping portion extending downwardly from the body, the clamping portion comprising first and second resilient members, each of the first and second resilient members comprising a vertical side wall and an inwardly extending end segment, a cover member for the body, the cover member having an arcuate configuration and being sized to fit between the first and second side walls, the cover member having first and second cover channels formed on an exteriorly facing surface the channels extending transversely thereof, each of the first and second cover channels being aligned with the body channels formed on the bottom wall.

According to a further aspect of the present invention, in a building having a plurality of pipes and truss members and wherein the pipes include a vertical portion, the improvement comprising a pipe support assembly secured to a vertically extending truss member, the pipe support assembly comprising a body having a recess formed therein, the recess having a generally U-shaped configuration and being open at a top end thereof, the recess being defined by a bottom wall and first and second side walls, a plurality of ribs on an extension surface of the bottom wall, at least four of the ribs extend transversely thereof to define first and second spaced apart body channels, a clamping portion extending downwardly from the body, the clamping portion comprising first and second resilient members, each of the first and second resilient members comprising a vertical side wall and an inwardly extending end segment, a cover member for the body, the cover member having an arcuate configuration and being sized to fit between the first and second side walls, the cover member having first and second cover channels formed on an exteriorly facing surface the channels extending transversely thereof, each of the first and second cover channels being aligned with the body channels formed on the bottom wall.

The pipe support assembly of the present invention is designed to be used for vertically extending pipes and to this end, there is provided a cover member which is secured to the bottom member by means of a tie wrap.

### BRIEF DESCRIPTION OF THE DRAWINGS

Having thus generally described the invention, reference will be made to the accompanying drawings illustrating an embodiment thereof, in which:

FIG. 1 is a perspective view of a pipe support assembly according to one embodiment of the present invention with a pipe being shown in phantom;

FIG. 2 is a side elevational thereof;

FIG. 3 is a cross sectional view taken along the lines 3-3 of FIG. 2;

FIG. 4 is a cross sectional view taken along the lines 4-4 of FIG. 2;

FIG. 5 is a top plan view thereof; and

FIG. 6 is a bottom plan view of the upper cover member.

### DETAILED DESCRIPTION OF THE INVENTION

Referring to the drawings in greater detail, and by reference characters thereto, there is illustrated a pipe support assembly which is generally designated by reference numeral 5.

Pipe support assembly 5 includes a lower support member 10 and an upper support member 11. Lower support member 10 includes a central body portion generally designated by reference numeral 12 and which body portion 12 comprises a bottom wall 14 which of an arcuate configuration and upwardly extending side walls 16 and 18.

On the exterior facing surface of bottom wall 14 and side walls 16, 18 there are provided spaced transverse flanges 20. As will be noted, there are also provided longitudinally extending flanges 22, with three such flanges being illustrated.

Lower support 10 is designed to be attached to a trust type support and to this end, there are provided a pair of fastening or clamping members generally designated by reference numerals 24 and 26. Fastening members 24, 26 each have a respective side wall 28, 30 which extends outwardly from bottom wall 14. Each side wall 28, 30 in turn has respective inwardly extending end segments 32, 34. End segments 32, 34 have a respective end wall 36, 38 such that there is defined therebetween a recess designed to fit around a trust member. Naturally, it will be understood that side walls 28, 30 are somewhat flexible or resilient in order that they can be placed about the trust member.

At one end of pipe support of member 10, there is provided an extended tongue portion generally designated by reference numeral 40. It will be noted that there is provided a rib 42 extending thereabout for reasons which will be discussed hereinbelow. Similarly, at the other end of central body portion 12, there is provided a second extended tongue 44 having rib 46 associated therewith. Each one of tongues 40, 44 is characterized by a side wall which is of a lesser height than a central portion of the side walls.

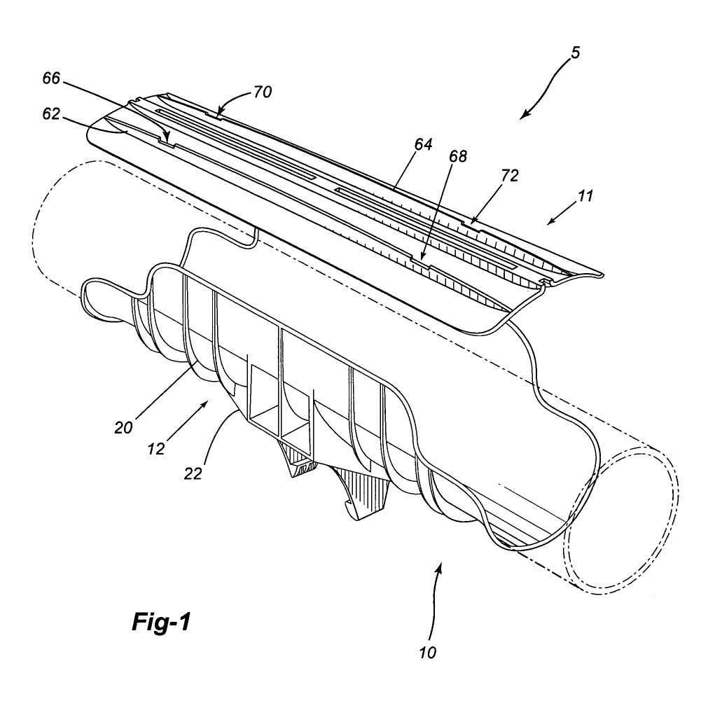

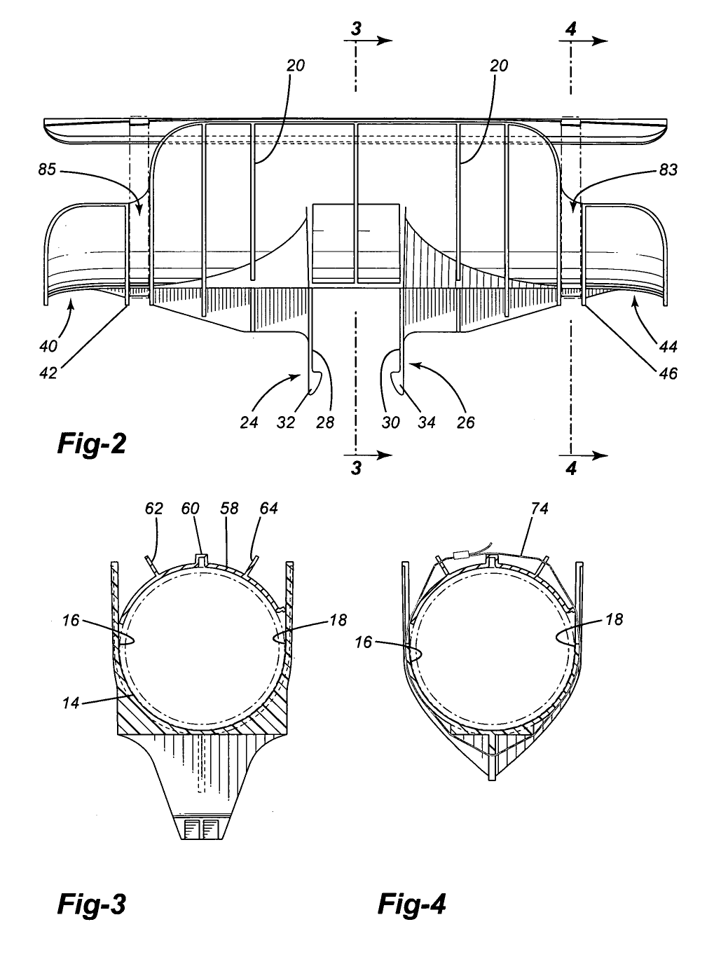

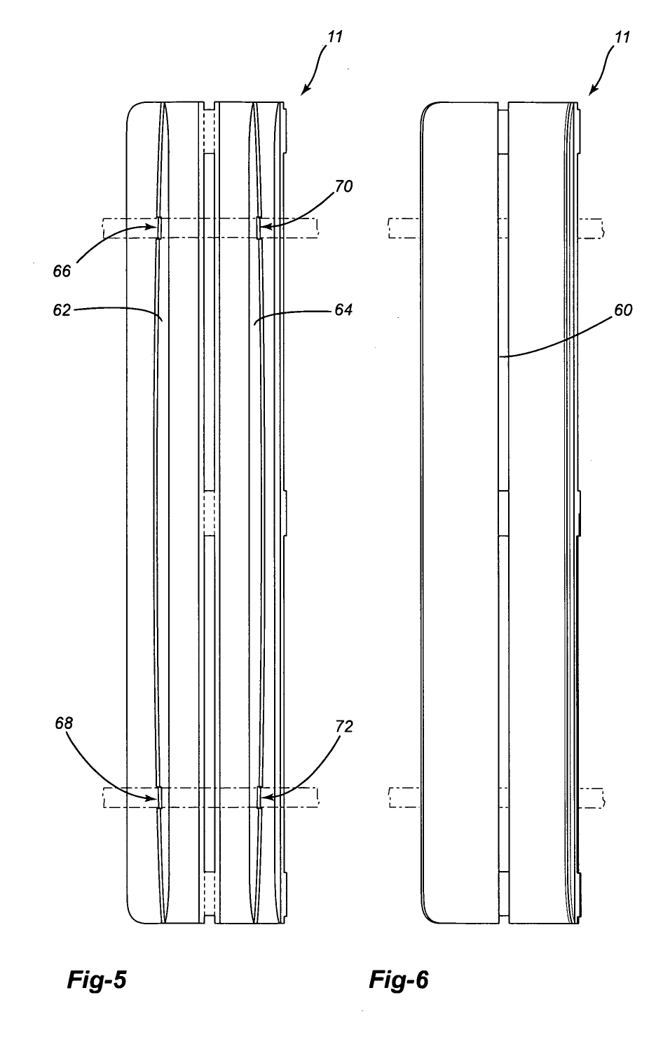

Upper support member 11 has an arcuate body 58 which includes a centre channel 60 extending in a longitudinal direction. On the outer facing surface of upper support member 11, there are provided a pair of longitudinally extending flanges 62 and 64. As may be seen in FIG. 1, there are provided a pair of notches or recesses 66, 68 in flange 62. Similarly, a pair of notches 70, 72 are provided in flange 64.

As previously mentioned, there is provided a rib 42 in extended tongue portion 40 and which, with a rib in the main body portion, defines a channel 85 at the point of juncture of the extended tongue portion 40 with main body portion 12. Similarly, at the other end, there is provided a channel 83 partially defined by rib 46.

The arrangement is such that once a pipe is placed in lower support member 10, cover portion 11 may then be placed thereabout and a tie wrap 74 used to secure cover 11 to body portion 12. Tie wrap 74 may be then be secured in position and tightened as it passes within a respective channel 83, 85 and notches 66, 68, 70 and 72.

It will be understood that the above described embodiment is for purposes of illustration only and that changes and modifications may be made thereto without departing from the spirit and scope of the invention.

I claim:

1. A pipe support assembly comprising:
a body having a recess formed therein, said recess having a generally U-shaped configuration and being open at a top end thereof;
said recess being defined by a bottom wall and first and second side walls;
a plurality of ribs on an exterior surface of said bottom wall, at least four of said ribs extend transversely thereof to define first and second spaced apart body channels;
a clamping portion extending downwardly from said body, said clamping portion comprising first and second resilient members;
each of said first and second resilient members comprising a vertical side wall and an inwardly extending end segment;
a cover member for said body, said cover member having an arcuate configuration and being sized to fit between said first and second side walls;
said cover member having first and second cover channels formed on an exteriorly facing surface said channels extending transversely thereof, each of said first and second cover channels being aligned with said body channels formed on said bottom wall.

2. The pipe support of claim 1 wherein said pipe support is formed of a plastic material.

3. The pipe support member of claim 2 wherein said first and second side walls each have a central portion and a pair of end portions, said central portion extending upwardly from said bottom wall a greater distance than said end portions.

4. The pipe support of claim 3 wherein said body channels are located proximate a point where a respective end portion meets said central portion.

5. In the building having a plurality of pipes and truss members and wherein said pipes include a vertical portion, the improvement comprising a pipe support assembly secured to a vertically extending truss member, said pipe support assembly comprising:
a body having a recess formed therein, said recess having a generally U-shaped configuration and being open at a top end thereof;
said recess being defined by a bottom wall and first and second side walls;
a plurality of ribs on an extension surface of said bottom wall, at least four of said ribs extend transversely thereof to define first and second spaced apart body channels;
a clamping portion extending downwardly from said body, said clamping portion comprising first and second resilient members;
each of said first and second resilient members comprising a vertical side wall and an inwardly extending end segment;
a cover member for said body, said cover member having an arcuate configuration and being sized to fit between said first and second side walls;
said cover member having first and second cover channels formed on an exteriorly facing surface said channels extending transversely thereof, each of said first and second cover channels being aligned with said body channels formed on said bottom wall.
